(19) United States
(12) Patent Application Publication
(10) Pub. No.: US 2021/0356291 A1
(43) Pub. Date: Nov. 18, 2021

(54) INFORMATION PROCESSING DEVICE, PARKING LOT RECOMMENDATION SYSTEM, PARKING LOT RECOMMENDATION METHOD, AND NON-TRANSITORY STORAGE MEDIUM

(71) Applicant: Toyota Jidosha Kabushiki Kaisha, Toyota-shi (JP)

(72) Inventors: Shodai Kato, Nisshin-shi (JP); Toru Sakamoto, Anjo-shi (JP)

(73) Assignee: Toyota Jidosha Kabushiki Kaisha, Toyota-shi (JP)

(21) Appl. No.: 17/246,207

(22) Filed: Apr. 30, 2021

(30) Foreign Application Priority Data
May 13, 2020 (JP) 2020-084397

(51) Int. Cl. G01C 21/36; G01C 21/34

(52) U.S. Cl. CPC G01C 21/3691; G01C 21/3461; G01C 21/3415; G01C 21/3492

(57) ABSTRACT

An information processing device includes one or more processors configured to: acquire an indoor distance and an outdoor distance of a transfer route from each of a plurality of parking lots as recommendation candidates to a specific location; acquire weather information on weather around the specific location; calculate an evaluation value based on the indoor distance and the outdoor distance for each of the parking lots, the evaluation value being a value varying depending on the weather information; and generate recommendation information for a parking lot based on the evaluation value.

### CROSS-REFERENCE TO RELATED APPLICATION

This application claims priority to Japanese Patent Application No. 2020-084397 filed on May 13, 2020, incorporated herein by reference in its entirety.

### BACKGROUND

### 1. Technical Field

The present disclosure relates to an information processing device, a parking lot recommendation system, a parking lot recommendation method, and a non-transitory storage medium.

### 2. Description of Related Art

There is known a navigation device that provides guidance on a parking lot around a destination. Japanese Unexamined Patent Application Publication No. 2011-128100 (JP 2011-128100 A), for example, describes a navigation device that presents a parking lot to which an indoor transfer flag is set, among parking lots corresponding to a destination, when it is rainy.

### SUMMARY

In the technique described in the document described above, however, the indoor transfer flag indicates a parking lot that enables transfer from the parking lot to the destination through only an indoor path. Therefore, this technique cannot propose a parking lot as a departure place of a transfer route to the destination including both indoor and outdoor paths on rainy days, for example.

The present disclosure provides an information processing device, a parking lot recommendation system, a parking lot recommendation method, and a program that can recommend a parking lot that is suitable for the weather, among the parking lots as the departure places of the transfer routes of which the destination is the specific location and which includes both indoor and outdoor paths.

An information processing device according to a first aspect of the present disclosure includes an information processing device comprising one or more processors configured to: acquire an indoor distance and an outdoor distance of a transfer route from each of a plurality of parking lots as recommendation candidates to a specific location; acquire weather information on weather around the specific location; calculate an evaluation value based on the indoor distance and the outdoor distance for each of the parking lots, the evaluation value being a value varying depending on the weather information; and generate recommendation information for a parking lot based on the evaluation value.

A parking lot recommendation system according to a second aspect of the present disclosure includes an information processing device and a terminal device. The information processing device includes one or more first processors configured to acquire an indoor distance and an outdoor distance of a transfer route from each of a plurality of parking lots as recommendation candidates to a specific location, acquire weather information on weather around the specific location, calculate an evaluation value based on the indoor distance and the outdoor distance for each of the parking lots, the evaluation value being a value varying depending on the weather information, and generate recommendation information for a parking lot based on the evaluation value. The terminal device includes one or more second processors configured to cause an output device to output the parking lot recommended by the first processors.

A parking lot recommendation method according to a third aspect of the present disclosure includes: acquiring, by one or more processors, an indoor distance and an outdoor distance of a transfer route from each of a plurality of parking lots as recommendation candidates to a specific location; acquiring, by the one or more processors, weather information on weather around the specific location; calculating, by the one or more processors, an evaluation value based on the indoor distance and the outdoor distance for each of the parking lots, the evaluation value being a value varying depending on the weather information; and generating, by the one or more processors, recommendation information for a parking lot based on the evaluation value.

A non-transitory storage medium according to a fourth aspect of the present disclosure storing instructions that are executable by one or more processors and that cause the one or more processors to perform functions includes: acquiring an indoor distance and an outdoor distance of a transfer route from each of a plurality of parking lots as recommendation candidates to a specific location; acquiring weather information on weather around the specific location; calculating an evaluation value based on the indoor distance and the outdoor distance for each of the parking lots, the evaluation value being a value varying depending on the weather information; and generating recommendation information for a parking lot based on the evaluation value.

With the present disclosure, it is possible to provide an information processing device, a parking lot recommendation system, a parking lot recommendation method, and a program that can recommend a parking lot that is suitable for the weather, among the parking lots as departure places of transfer routes of which a destination is the specific location and which includes both indoor and outdoor paths.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an example of the system configuration of a parking lot recommendation system according to an embodiment;

FIG. 2 is a block diagram illustrating an example of the hardware configuration of an information processing device according to the embodiment;

FIG. 3 is a block diagram illustrating an example of the functional configuration of an information processing device according to a first embodiment;

FIG. 4 is a block diagram illustrating an example of the hardware configuration of a terminal device according to the embodiment;

FIG. 5 is a block diagram illustrating an example of the functional configuration of the terminal device according to the embodiment;

FIG. 6 is a flowchart illustrating an example of a recommendation process performed by the parking lot recommendation system according to the embodiment;

FIG. 7 is a flowchart illustrating an example of a parameter value change process performed by the information processing device according to the embodiment; and

FIG. 8 is a block diagram illustrating an example of the functional configuration of an information processing device according to a second embodiment.

### DETAILED DESCRIPTION OF EMBODIMENTS

Embodiments of the present disclosure will be described below with reference to the drawings. In order to clarify description, the following description and the drawings are omitted and simplified as appropriate. In the drawings, in addition, identical elements are given identical signs to omit redundant description as necessary.

### First Embodiment

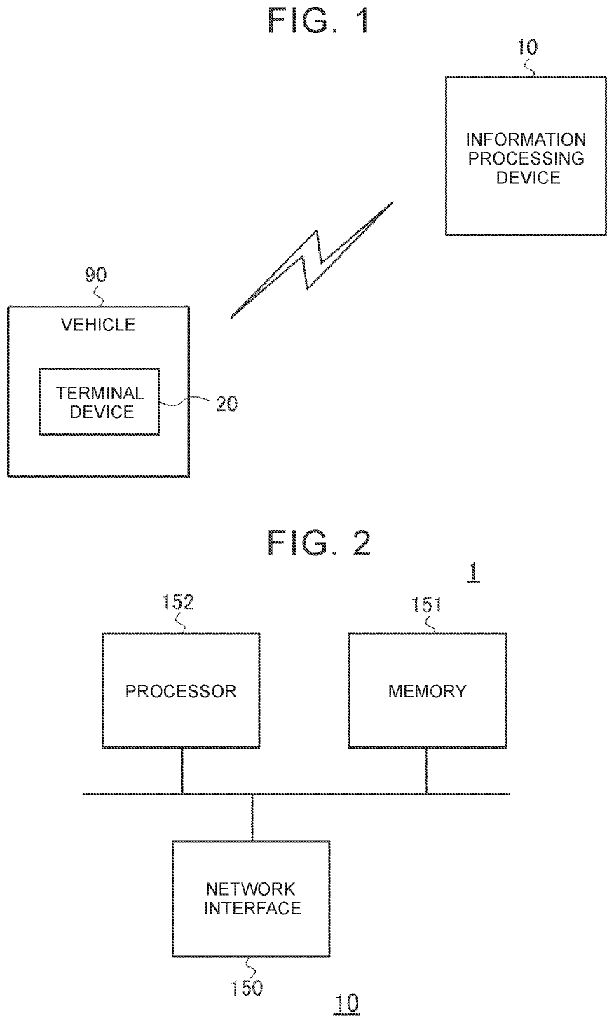

FIG. 1 is a schematic diagram illustrating an example of the system configuration of a parking lot recommendation system 1 according to an embodiment. The parking lot recommendation system 1 has an information processing device 10 and a terminal device 20.

In the present embodiment, by way of example, the terminal device 20 is mounted on a vehicle 90. However, the terminal device 20 may not necessarily be mounted on a vehicle. For example, the terminal device 20 may be a portable terminal such as a smartphone or a tablet terminal. The information processing device 10 is a device that functions as a server. The information processing device 10 and the terminal device 20 are communicably connected to each other via a communication network such as a cellular phone network.

First, the information processing device 10 will be specifically described. FIG. 2 is a block diagram illustrating an example of the hardware configuration of the information processing device 10. As illustrated in FIG. 2, the information processing device 10 includes a network interface 150, a memory 151, and a processor 152.

The network interface 150 is used to communicate with any different device. In the present embodiment, the network interface 150 is used to communicate with the terminal device 20, for example.

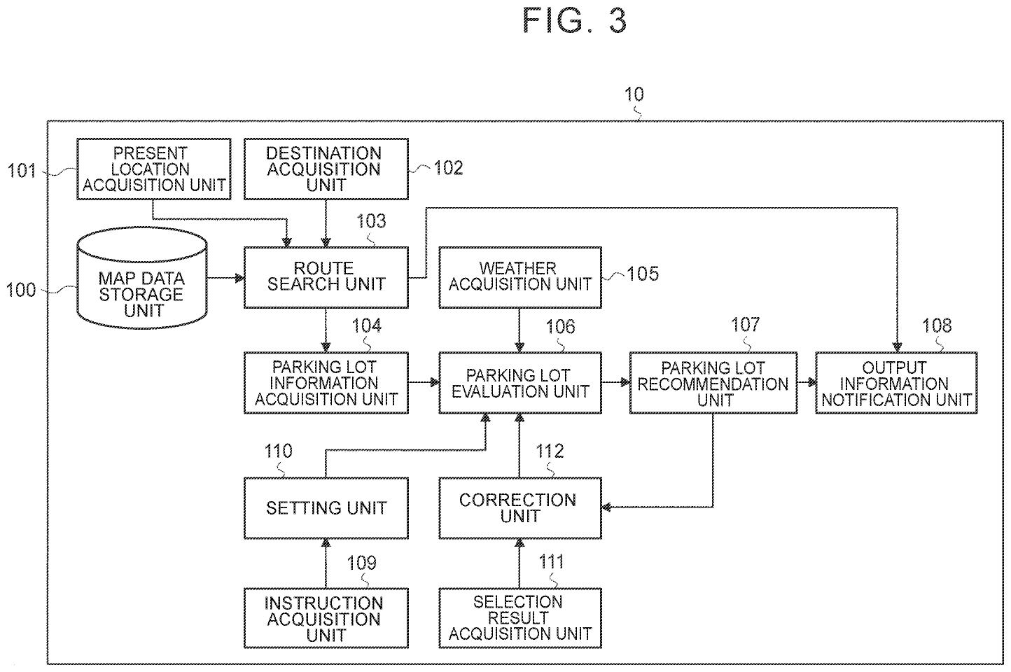

The memory 151 is constituted by a combination of a volatile memory and a non-volatile memory, for example. The memory 151 is used to store software (computer program) that includes one or more instructions to be executed by the processor 152, data to be used for various processes performed by the information processing device 10, etc. A map data storage unit 100 illustrated in FIG. 3 to be described later is implemented by the memory 151, for example. However, the map data storage unit 100 may be implemented by a different storage device.

The processor 152 reads software (computer program) from the memory 151 and executes the software (computer program) to perform processes of constituent elements illustrated in FIG. 3 to be described later. Specifically, the processor 152 performs processes of a present location acquisition unit 101, a destination acquisition unit 102, a route search unit 103, a parking lot information acquisition unit 104, a weather acquisition unit 105, a parking lot evaluation unit 106, a parking lot recommendation unit 107, an output information notification unit 108, an instruction acquisition unit 109, a setting unit 110, a selection result acquisition unit 111, and a correction unit 112.

The processor 152 may be a microprocessor, a micro-processing unit (MPU), or a central processing unit (CPU), for example. The processor 152 may include a plurality of processors. In this manner, the information processing device 10 is a device that functions as a computer.

FIG. 3 is a block diagram illustrating an example of the functional configuration of the information processing device 10 according to a first embodiment. As illustrated in FIG. 3, the information processing device 10 has the map data storage unit 100, the present location acquisition unit 101, the destination acquisition unit 102, the route search unit 103, the parking lot information acquisition unit 104, the weather acquisition unit 105, the parking lot evaluation unit 106, the parking lot recommendation unit 107, the output information notification unit 108, the instruction acquisition unit 109, the setting unit 110, the selection result acquisition unit 111, and the correction unit 112.

The map data storage unit 100 stores map data. The map data include road map data, data on the positions of facilities such as parking lots, etc. In the present embodiment, in particular, the map data stored in the map data storage unit 100 include so-called indoor maps, in order to allow a search for a transfer route for people. That is, the map data stored in the map data storage unit 100 include maps of roads for passage of vehicles, and also include maps of passages for pedestrians. The maps of passages for pedestrians indicate passages outside buildings on the ground, and also indicate passages inside the buildings and underground passages. The passages inside the buildings may include passages for transfer between floors. For the passages outside the buildings on the ground, the map data may include information that indicates whether the upper side of the passage is covered with a structure that blocks sunlight or rain such as a roof. In this manner, the map data storage unit 100 stores map data including information for specifying whether the transfer route is an outdoor path or an indoor path. The term “indoor” refers to a location of which the upper side is covered with a structure that blocks sunlight or rain such as a roof. The indoor locations include a space inside a building, an underground passage, and a ground passage with a roof. Meanwhile, the term “outdoor” refers to a location of which the upper side is not covered with a structure that blocks sunlight or rain such as a roof

The present location acquisition unit 101 acquires the present location of a user, that is, the present location of the terminal device 20 (vehicle 90). Specifically, the present location acquisition unit 101 acquires, via the network interface 150, information on the present location transmitted from the terminal device 20. The information on the present location acquired by the present location acquisition unit 101 is used for a process by the route search unit 103.

The destination acquisition unit 102 acquires a destination designated by the user. Specifically, the destination acquisition unit 102 acquires, via the network interface 150, information on the destination transmitted from the terminal device 20 each time the destination is designated on the terminal device 20. The information on the destination acquired by the destination acquisition unit 102 is used for a process by the route search unit 103.

The route search unit 103 searches for a route, and calculates the distance of the route. The route search unit 103 searches for a route using any known route search algorithm, for example. Specifically, the route search unit 103 performs the following process.

The route search unit 103 searches for a route from the present location to the destination using the present location of the user (terminal device 20) acquired by the present location acquisition unit 101, the destination acquired by the destination acquisition unit 102, and the map data stored in the map data storage unit 100. This route search is a search for a route for transfer on the vehicle 90.

The route search unit 103 also searches for a transfer route from a parking lot to the destination for each of parking lots around the destination acquired by the destination acquisition unit 102. This route search is a search for a route for transfer of people on foot. For example, the route search unit 103 searches for parking lots around the destination (e.g. parking lots that exist within a predetermined range from the destination) with reference to the map data stored in the map data storage unit 100. Then, the route search unit 103 searches for a transfer route (e.g. the shortest transfer route) from the parking lot to the destination for each of the parking lots found in the search. In addition, when a transfer route from the parking lot to the destination is found in the search, the route search unit 103 calculates an indoor distance and an outdoor distance of the transfer route. As described above, the map data include information for specifying whether the transfer route is an outdoor path or an indoor path. Therefore, in the present embodiment, the route search unit 103 calculates the indoor distance and the outdoor distance of the found transfer route with reference to the map data. For example, when a certain transfer route leads from the parking lot to the destination through an indoor passage and an outdoor passage, the route search unit 103 calculates each of the distance of the indoor passage and the distance of the outdoor passage. The transfer route may not necessarily include both an indoor passage and an outdoor passage. Thus, the calculated indoor distance or outdoor distance may be zero.

The route search unit 103 outputs the found route from the present location to the destination to the output information notification unit 108. The route search unit 103 may output the found route from the parking lot to the destination to the output information notification unit 108. In addition, the route search unit 103 outputs the indoor distance and the outdoor distance of the transfer route from each parking lot to the destination to the parking lot information acquisition unit 104.

The parking lot information acquisition unit 104 acquires, for each of parking lots as recommendation candidates, the indoor distance and the outdoor distance of the transfer route from the parking lot to a specific location. In the present embodiment, the specific location is the destination acquired by the destination acquisition unit 102, by way of example. In addition, the parking lots around the destination are specific examples of the parking lots as recommendation candidates. That is, in the present embodiment, the parking lot information acquisition unit 104 acquires, for each of the parking lots around the destination, the indoor distance and the outdoor distance of the transfer route from the parking lot to the destination. The parking lot information acquisition unit 104 acquires, for each parking lot, the indoor distance and the outdoor distance calculated by the route search unit 103. While the parking lot information acquisition unit 104 acquires the indoor distance and the outdoor distance calculated by the route search unit 103 in the present embodiment, the parking lot information acquisition unit 104 may acquire an indoor distance and an outdoor distance from a database that stores the indoor distance and the outdoor distance of a transfer route to a specific location for each of the parking lots as recommendation candidates when such a database exists. In this case, the process by the route search unit 103 may be omitted. The information acquired by the parking lot information acquisition unit 104 is used for a process by the parking lot evaluation unit 106.

The weather acquisition unit 105 acquires weather information on the weather around the specific location (destination in the present embodiment) described above. For example, the weather acquisition unit 105 acquires weather information via a network from a server (not illustrated) that provides weather information. The weather information is information on the present weather, for example, but may be information on the weather on a specified date and time. Specifically, the weather acquisition unit 105 may acquire the type of weather, for example, as the weather information. Examples of the type of weather include sunny, rainy, snowy, and cloudy. The type of the weather acquired by the weather acquisition unit 105 may be any of the 96 types of weather determined by the World Meteorological Organization (WMO), or may be determined more roughly. In addition, the weather acquisition unit 105 may acquire, as the weather information, at least one of the air temperature, precipitation amount, humidity, and wind speed around the specific location (destination in the present embodiment) described above. The weather information acquired by the weather acquisition unit 105 is used for a process by the parking lot evaluation unit 106.

The parking lot evaluation unit 106 calculates an evaluation value that is different in accordance with the weather information based on the indoor distance and the outdoor distance of the transfer route for each of the parking lots as recommendation candidates. Specifically, the parking lot evaluation unit 106 calculates an evaluation value for each parking lot by weighting the indoor distance and the outdoor distance in accordance with the weather information. In the present embodiment, the parking lot evaluation unit 106 calculates an evaluation value V using the following formula (1).

V=Lᵢₙ×Wᵢₙ+Lₒᵤₜ×Wₒᵤₜ (1)

In the formula, Lᵢₙ represents the indoor distance, and Lₒᵤₜ represents the outdoor distance. In addition, Wᵢₙ represents a weighting parameter for the indoor distance, and Wₒᵤₜ represents a weighting parameter for the outdoor distance. The evaluation value V is also considered as a value that indicates a transfer cost that reflects comfort, and represents a higher evaluation as the evaluation value V is smaller.

The parking lot evaluation unit 106 calculates an evaluation value for each parking lot by assigning different weights in accordance with whether it is rainy or snowy (hereinafter expressed as “rainy etc.”) or whether it is not rainy etc., for example. When it is rainy etc., for example, it is considered that the comfort of transfer through an outdoor passage is low compared to that through an indoor passage. Therefore, the length of the outdoor passage is more important than the length of the indoor passage. Hence, the parking lot evaluation unit 106 increases the value of Wₒᵤₜ, or reduces the value of Wᵢₙ, when it is rainy etc. compared to the case where it is not rainy etc., for example.

A specific example will be described. It is assumed that the indoor distance and the outdoor distance from a parking lot P₁ or a parking lot P₂ to a specific location are defined as follows.

<Parking lot P₁>indoor distance: 200 m, outdoor distance: 50 m

<Parking lot P₂>indoor distance: 100 m, outdoor distance: 100 m

Then, the parking lot evaluation unit 106 calculates an evaluation value using Wᵢₙ=Wₒᵤₜ=1, for example, as weighing parameters when it is not rainy etc. (i.e. it is sunny or cloudy), and calculates an evaluation value using Wᵢₙ=1 and Wₒᵤₜ=3, for example, as weighting parameters when it is rainy etc. In this case, when it is not rainy etc., the evaluation value V of the parking lot P₁ is 200×1+50×1=250, and the evaluation value V of the parking lot P₂ is 100×1 100×1=200. Thus, the parking lot P₂ with a shorter total distance of the indoor distance and the outdoor distance has a smaller evaluation value (transfer cost), and is evaluated more highly. When it is rainy etc., on the contrary, the evaluation value V of the parking lot P₁ is 200×1+50×3=350, and the evaluation value V of the parking lot P₂ is 100×1 100×3=400. Thus, the parking lot P₁ with a shorter outdoor distance has a smaller evaluation value (transfer cost), and is evaluated more highly.

In this manner, the parking lot evaluation unit 106 may change the values of the weighting parameters in accordance with the type of weather. Consequently, evaluations of the parking lots in accordance with the type of weather can be obtained, which makes it possible to recommend a parking lot that is suitable for the type of weather. The parking lot evaluation unit 106 may change the values of the weighting parameters in accordance with at least one of the type of weather, air temperature, precipitation amount, humidity, and wind speed. Consequently, evaluations of the parking lots in accordance with the air temperature etc. can be obtained, which makes it possible to recommend a parking lot that is suitable for the air temperature etc. When the air temperature or the humidity is significantly high, or the wind speed is significantly high, for example, it is considered that the comfort of transfer through an outdoor passage is low compared to that through an indoor passage, even when it is not rainy etc. Therefore, the length of the outdoor distance is more important than the length of the indoor distance also in the case of such weather. Hence, the parking lot evaluation unit 106 may increase the value of Wₒᵤₜ, or reduce the value of Wᵢₙ, when the air temperature or the humidity is more than a predetermined threshold, or when the wind speed is more than a predetermined threshold, compared to the case where such a value is not more than the threshold, for example. Meanwhile, it is considered that the comfort of transfer through an outdoor passage is not substantially impaired when the precipitation amount is slight, even when it is rainy etc. Thus, the parking lot evaluation unit 106 may increase the value of Wₒᵤₜ, or reduce the value of Wᵢₙ, when it is rainy etc. and the precipitation amount is more than a predetermined threshold compared to the case where the precipitation amount is not more than the threshold, for example. The method of changing weighting in accordance with weather information described above is merely exemplary, and the parking lot evaluation unit 106 may adopt a different change method as the method of changing weighting in accordance with weather information.

The parking lot recommendation unit 107 generates parking lot recommendation information based on the result of evaluation by the parking lot evaluation unit 106. That is, the parking lot recommendation unit 107 generates parking lot recommendation information based on the evaluation value (i.e. transfer cost) of each of the parking lots as recommendation candidates calculated by the parking lot evaluation unit 106. The recommendation information may be information that indicates the result of sorting the parking lots in the descending order of the evaluation (i.e. ascending order of the evaluation value V) in accordance with the evaluation result, or may be information that indicates a recommended parking lot, for example. The recommended parking lot is a parking lot with the highest evaluation (i.e. the smallest evaluation value V), for example.

The output information notification unit 108 notifies an output control unit 204 of the terminal device 20 of information related to an output from the terminal device 20. The output information notification unit 108 notifies the output control unit 204 of the recommendation information generated by the parking lot recommendation unit 107, for example. Consequently, the output control unit 204 can output recommendation information in accordance with the weather. When the terminal device 20 does not retain map data, the output information notification unit 108 may transmit map data to the terminal device 20. In addition, the output information notification unit 108 may notify the output control unit 204 of the route found by the route search unit 103. Consequently, the output control unit 204 can output the route on a map.

While the parking lot evaluation unit 106 uses predetermined values in accordance with the weather information as the parameter values for weighting, the parameter values for weighting may be set in accordance with an instruction from the user. That is, the parameter values may be changed in accordance with an instruction from the user. In order to implement this function, the information processing device 10 may have the instruction acquisition unit 109 and the setting unit 110.

The instruction acquisition unit 109 acquires an instruction related to weighting from the user. Specifically, the instruction acquisition unit 109 acquires, via the network interface 150, an instruction related to weighting from the user input to the terminal device 20 and transmitted from the terminal device 20. The instruction acquired by the instruction acquisition unit 109 is used for a process by the setting unit 110. This instruction may be an instruction to specifically designate the value of Wᵢₙ or Wₒᵤₜ described above, or may be an instruction to designate an index value for the degree of allowance of outdoor transfer.

The setting unit 110 sets the parameter values for weighting, which are calculated by the parking lot evaluation unit 106, based on the instruction related to weighting from the user acquired by the instruction acquisition unit 109. For example, when an instruction to specifically designate the value of Wᵢₙ or Wₒᵤₜ is obtained, the setting unit 110 uses the designated value as the parameter value. Meanwhile, when an instruction to designate an index value for the degree of allowance of outdoor transfer is obtained, for example, the setting unit 110 sets a larger value as the value of Wₒᵤₜ, or sets a smaller value as the value of Wᵢₙ, as the degree of allowance of outdoor transfer is smaller.

With such a configuration, the parameter values for weighting are set in accordance with an instruction from the user. Therefore, the user can adjust the evaluation value calculation method such that recommendation that suits preference of the user is obtained.

In addition, the parameter values for weighting may be corrected automatically when the recommendation information generated by the parking lot recommendation unit 107 does not suit the preference of the user. In order to implement this function, the information processing device 10 may have the selection result acquisition unit 111 and the correction unit 112.

The selection result acquisition unit 111 acquires a selection result that indicates which parking lot has been selected by the user who references the generated recommendation information. Specifically, the selection result acquisition unit 111 acquires, via the network interface 150, the selection result transmitted from the terminal device 20. The selection result acquired by the selection result acquisition unit 111 is used for a process by the correction unit 112. The terminal device 20 may specify which parking lot has been selected by receiving an input by the user to select a parking lot, or may specify which parking lot has been selected by determining, from the present location information, which parking lot is visited after the recommendation information is output.

The correction unit 112 corrects the parameter values for weighting, which are calculated by the parking lot evaluation unit 106, when the user selects a parking lot that is different from the parking lot recommended in the recommendation information. For example, the correction unit 112 corrects the parameter values for weighting, which are calculated by the parking lot evaluation unit 106, when the parking lot selected by the user is different from the parking lot with the highest evaluation based on the evaluation value. Specifically, the correction unit 112 corrects the parameter values for weighting such that the evaluation of the parking lot selected by the user is higher than the evaluations of the other parking lots as recommendation candidates. That is, the correction unit 112 corrects the parameter values for weighting such that the evaluation value V (transfer cost) of the selected parking lot is the smallest of the evaluation values V of the parking lots as recommendation candidates.

With such a configuration, the evaluation value calculation method is corrected, since the parameter values for weighting are corrected when the recommendation by the parking lot recommendation unit 107 and the selection by the user do not coincide with each other. Therefore, it is possible to make a recommendation that suits the preference of the user.

Any method can be used as the method for the correction unit 112 to correct the parameter values for weighting. For example, the correction unit 112 may calculate corrected parameter values, by using the calculation formulas (1) for the evaluation value based on the indoor distance and the outdoor distance. Specifically, the correction unit 112 may calculate parameter values by solving simultaneous equations of a first formula and a second formula that are the calculation formulas (1) of which the weighting parameters are set as variables. The first formula is a formula that uses a first evaluation value and the indoor distance and the outdoor distance of the parking lot with the highest evaluation based on the evaluation value calculated by the parking lot evaluation unit 106. The first evaluation value is an evaluation value calculated for such distances using parameter values before being corrected. Meanwhile, the second formula is a formula that uses the indoor distance and the outdoor distance of the parking lot selected by the user and a second evaluation value varied from the first evaluation value described above by a predetermined value. The second evaluation value is a value varied so as to be evaluated more highly than the parking lot with the first evaluation value. In the present embodiment, a smaller evaluation value V (transfer cost) calculated is evaluated more highly, and therefore the second evaluation value is smaller than the first evaluation value by the predetermined value. Such a method will be specifically described using the parking lot P₁ and the parking lot P₂ described above as examples. Here, by way of example, correction of the parameter values for weighting for a case where it is not rainy etc. will be described.

The parameter values before being corrected are Wᵢₙ=Wₒᵤₜ=1. At this time, the evaluation value V of the parking lot P₁ is 200×1+50×1=250, and the evaluation value V of the parking lot P₂ is 100×1+100×1=200, and therefore the parking lot evaluation unit 106 evaluates the parking lot P₂ more highly. Meanwhile, it is assumed that the user selects the parking lot P₁, rather than the parking lot P₂. In this case, the correction unit 112 calculates corrected parameter values, by solving simultaneous equations of the first formula (Formula (2)) and the second formula (Formula (3)) provided below, for example. A value of 10 is used as the predetermined value described above. That is, the second formula derives 200-10=190 as the evaluation value on the right side.

First formula(formula for parking lot P₂): 100×Wᵢₙ+100×Wₒᵤₜ=200 (2)

Second formula(formula for parking lot P₁): 200×Wᵢₙ+50×Wₒᵤₜ=200−10 (3)

In this example, the solutions to the simultaneous equations are Wᵢₙ=0.6 and Wₒᵤₜ=1.4. When the values are used as corrected parameter values, the evaluation value V of the parking lot P₁ is 190, and the evaluation value V of the parking lot P₂ is 200. Therefore, the parking lot P₁ is evaluated more highly in the next calculation of evaluation values. Therefore, it is possible to make a recommendation that suits the preference of the user.

The method for the correction unit 112 to correct the parameter values for weighting is not limited to the method described above. For example, the correction unit 112 may calculate parameter values that reflect the preference of the user using machine learning.

In addition, the values of the weighting parameters may be managed for each user. That is, the values of the weighting parameters may be set to different values for each user.

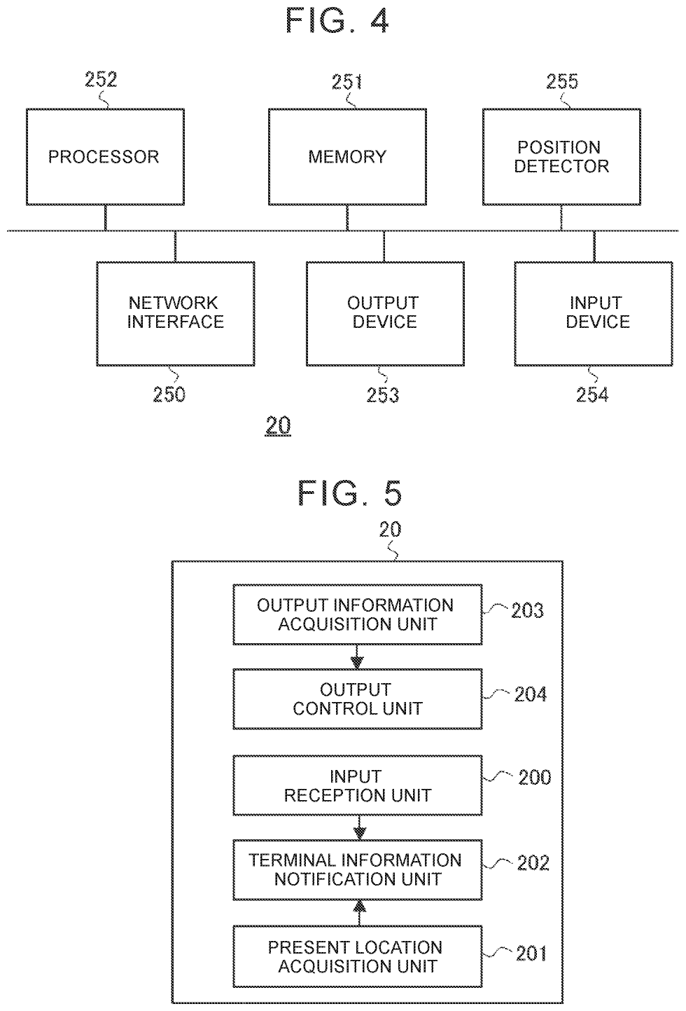

Next, the terminal device 20 will be specifically described. FIG. 4 is a block diagram illustrating an example of the hardware configuration of the terminal device 20. As illustrated in FIG. 4, the terminal device 20 includes a network interface 250, a memory 251, a processor 252, an output device 253, an input device 254, and a position detector 255.

The network interface 250 is used to communicate with any different device. For example, the network interface 250 may be an interface connected to a controller area network (CAN) of the vehicle 90. In the present embodiment, the network interface 250 is used to communicate with the information processing device 10, for example.

The memory 251 is constituted by a combination of a volatile memory and a non-volatile memory, for example. The memory 251 is used to store software (computer program) that includes one or more instructions to be executed by the processor 252, data to be used for various processes performed by the terminal device 20, etc. For example, the memory 251 may store map data, or may store detailed information on the parking lots. Such stored information may be provided from the information processing device 10.

The processor 252 reads software (computer program) from the memory 251 and executes the software (computer program) to perform processes of constituent elements illustrated in FIG. 5 to be described later. Specifically, the processor 252 performs processes of an input reception unit 200, a present location acquisition unit 201, a terminal information notification unit 202, an output information acquisition unit 203, and the output control unit 204.

The processor 252 may be a microprocessor, an MPU, or a CPU, for example. The processor 252 may include a plurality of processors. In this manner, the terminal device 20 is a device that functions as a computer.

The program described above executed by the information processing device 10 or the terminal device 20 can be stored using a non-transitory computer readable medium of various types and supplied to a computer. The non-transitory computer readable medium may include a tangible storage medium of various types. Examples of the non-transitory computer readable medium include a magnetic storage medium (e.g. a flexible disk, a magnetic tape, and a hard disk drive), a magneto-optical storage medium (e.g. a magneto-optical disk), a compact disc (CD) read only memory (ROM), a compact disc recordable (CD-R), a compact disc rewritable (CD-R/W), and a semiconductor memory (e.g. a mask ROM, a programmable ROM (PROM), an erasable PROM (EPROM), a flash ROM, and a random access memory (RAM)). In addition, the program may be supplied to a computer through a transitory computer readable medium of various types. Examples of the transitory computer readable medium include an electric signal, an optical signal, and an electromagnetic wave. The transitory computer readable medium can supply the program to a computer via a wired communication path such as an electric wire or optical fibers or a wireless communication path.

The output device 253 is a device that outputs information to the outside in order to provide the information to the user. The output device 253 may output display, or may output a sound, for example. When the output device 253 outputs display, specific examples of the output device 253 include a flat panel display such as a liquid crystal display, a plasma display, and an organic electro-luminescence (EL) display. When the output device 253 outputs a sound, meanwhile, specific examples of the output device 253 include a speaker.

The input device 254 is a device that receives an input from the user. For example, the input device 254 may be integrated with a display to be constituted as a touch panel.

The position detector 255 detects the present position of the terminal device 20 (vehicle 90). The position detector 255 may be a global navigation satellite system (GNSS) receiver, for example, or may be a gyroscope etc.

FIG. 5 is a block diagram illustrating an example of the functional configuration of the terminal device 20. As illustrated in FIG. 5, the terminal device 20 has the input reception unit 200, the present location acquisition unit 201, the terminal information notification unit 202, the output information acquisition unit 203, and the output control unit 204.

The input reception unit 200 receives an input from the user via the input device 254. For example, the input reception unit 200 receives an input to designate a destination from the user. The input reception unit 200 also receives an input of an instruction related to weighting from the user. The input reception unit 200 may receive an input to select a parking lot from the user who has referenced the recommendation information. In this case, the user references the recommendation information, and selects a parking lot to actually use, for example.

The present location acquisition unit 201 acquires information that indicates the present location of the terminal device 20 (vehicle 90). Specifically, the present location acquisition unit 201 acquires position information detected by the position detector 255.

The terminal information notification unit 202 notifies the information processing device 10 of the information acquired by the terminal device 20. For example, when a destination is designated in an input from the user, the terminal information notification unit 202 notifies the information processing device 10 of the present location and the destination designated in the input. The terminal information notification unit 202 may notify the information processing device 10 of the present location any time. The terminal information notification unit 202 is also referred to as a destination notification unit. With the information processing device 10, as described above, the indoor distance and the outdoor distance of a transfer route from a parking lot to the destination are acquired, and an evaluation value is calculated based on such distances. Therefore, it is possible to recommend a parking lot that is suitable for visiting the destination.

When an input of an instruction related to weighting or an input to select a parking lot is received, in addition, the terminal information notification unit 202 notifies the information processing device 10 of such information. When the parameter values for weighting are managed for each user, the information processing device 10 is preferably notified of an input of an instruction related to weighting or an input to select a parking lot, together with information that identifies the user, such that the parameter values can be set or corrected for each user.

The output information acquisition unit 203 acquires information related to an output of the terminal device 20 from the information processing device 10. Specifically, the output information acquisition unit 203 acquires, via the network interface 250, information output from the output information notification unit 108 of the information processing device 10. The output information acquisition unit 203 acquires the recommendation information generated by the parking lot recommendation unit 107 and the route found by the route search unit 103, for example, as the information related to an output. The information related to an output acquired by the output information acquisition unit 203 is output under control by the output control unit 204.

The output control unit 204 controls the output of information from the output device 253. The output control unit 204 performs control so as to display the recommendation information on a display, for example.

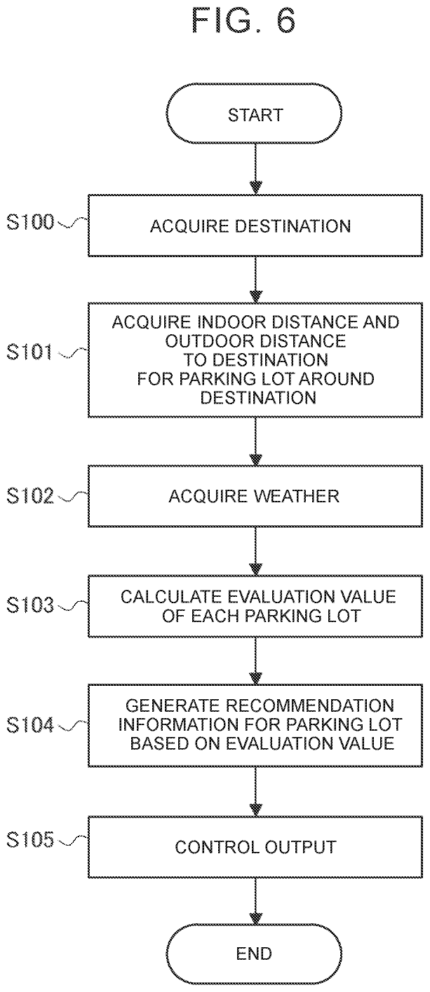

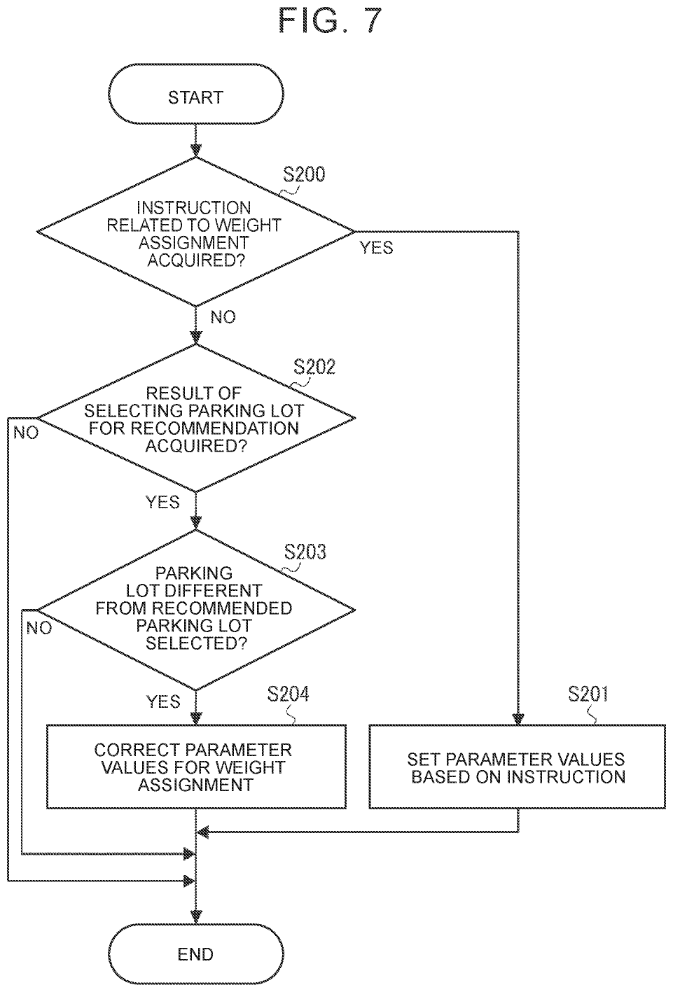

Next, the flow of a recommendation process performed by the parking lot recommendation system 1 will be described. FIG. 6 is a flowchart illustrating an example of the recommendation process performed by the parking lot recommendation system 1. The flow of the process will be described below with reference to FIG. 6.

In step S100, the destination acquisition unit 102 acquires a destination (specific location) designated by the user.

Next, in step S101, the parking lot information acquisition unit 104 acquires an indoor distance and an outdoor distance to the destination for each of parking lots around the destination acquired in step S100. In the present embodiment, specifically, the route search unit 103 first searches, for each of the parking lots around the destination acquired by the destination acquisition unit 102, for a transfer route from the parking lot to the destination, and calculates the indoor distance and the outdoor distance of the found transfer route. Consequently, the parking lot information acquisition unit 104 acquires the indoor distance and the outdoor distance to the destination for each parking lot.

Next, in step S102, the weather acquisition unit 105 acquires weather information on the weather around the destination (specific location).

Next, in step S103, the parking lot evaluation unit 106 calculates an evaluation value for each parking lot by weighting the indoor distance and the outdoor distance in accordance with the weather information acquired in step S102.

Next, in step S104, the parking lot recommendation unit 107 generates parking lot recommendation information based on the evaluation value calculated in step S103. Then, the generated recommendation information is delivered to the terminal device 20 by the output information notification unit 108, and acquired by the output information acquisition unit 203.

Next, in step S105, the output control unit 204 of the terminal device 20 outputs the acquired recommendation information through the output device 253.

Next, the flow of a process of changing the parameter values for weighting performed by the information processing device 10 will be described. FIG. 7 is a flowchart illustrating an example of the parameter value change process performed by the information processing device 10. The flow of the process will be described below with reference to FIG. 7.

In step S200, the instruction acquisition unit 109 determines whether an instruction related to weighting has been acquired from the user. When such an instruction has been acquired, the process proceeds to step S201. When such an instruction has not been acquired, the process proceeds to step S202.

In step S201, the setting unit 110 sets the parameter values for weighting, which are calculated by the parking lot evaluation unit 106, based on the instruction related to weighting from the user acquired by the instruction acquisition unit 109.

In step S202, on the other hand, the selection result acquisition unit 111 determines whether the result of selecting a parking lot for recommendation has been acquired. When the selection result has not been acquired, the present process is ended. That is, the parameter values for weighting are not changed. When the selection result has been acquired, the process proceeds to step S203.

In step S203, the correction unit 112 determines whether the parking lot indicated in the selection result is different from the parking lot recommended in the recommendation information. When the two parking lots coincide with each other, the present process is ended. That is, the parameter values for weighting are not changed. When the two parking lots are different from each other, the process proceeds to step S204.

In step S204, the correction unit 112 corrects the parameter values for weighting, which are calculated by the parking lot evaluation unit 106, such that the evaluation of the parking lot selected by the user is higher than the evaluations of the other parking lots as recommendation candidates.

The embodiment has been described above. In the parking lot recommendation system 1, an evaluation value in accordance with the weather information is calculated based on the indoor distance and the outdoor distance of a transfer route to a specific location for each parking lot. Thus, an evaluation of a parking lot in accordance with the weather can be obtained in consideration of both the indoor distance and the outdoor distance. Then, the parking lot recommendation system 1 generates parking lot recommendation information based on the evaluation value. Therefore, it is possible to recommend a parking lot that is suitable for the weather, the transfer route from which to the specific location could include both indoor and outdoor paths.

### Second Embodiment

Next, a second embodiment will be described. The second embodiment is different from the first embodiment in that recommendation information is generated also in consideration of whether the parking lot is an indoor parking lot or an outdoor parking lot.

Differences from the first embodiment will be described below while omitting description of components and functions that are similar to those in accordance with the first embodiment.

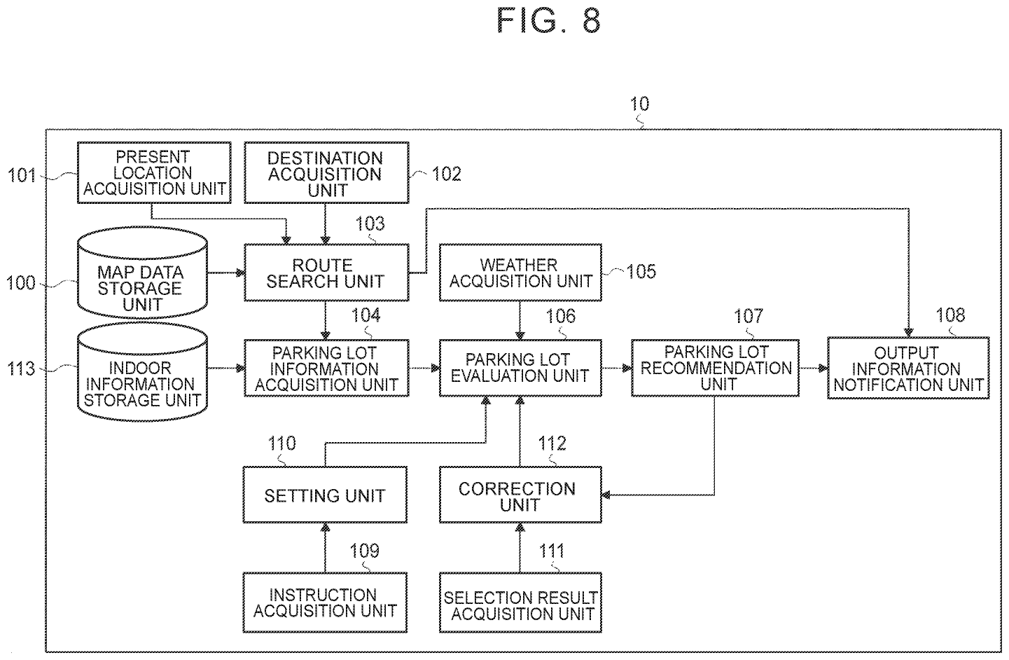

FIG. 8 is a block diagram illustrating an example of the functional configuration of an information processing device 10 according to the second embodiment. The configuration illustrated in FIG. 8 is different from the configuration illustrated in FIG. 3 in that an indoor information storage unit 113 is added.

The indoor information storage unit 113 stores, for each parking lot, indoor information that indicates whether the parking lot is an indoor parking lot or an outdoor parking lot. The indoor information storage unit 113 is implemented by the memory 151, for example. However, the indoor information storage unit 113 may be implemented by a different storage device.

In the present embodiment, the parking lot information acquisition unit 104 further acquires indoor information for each of parking lots as recommendation candidates. Specifically, the parking lot information acquisition unit 104 acquires the indoor information stored in the indoor information storage unit 113.

In the present embodiment, in addition, the parking lot recommendation unit 107 generates parking lot recommendation information based on the evaluation value calculated by the parking lot evaluation unit 106 and the indoor information. For example, the parking lot recommendation unit 107 may extract only indoor parking lots, among parking lots around the specific location (destination), and generate recommendation information for the extracted parking lots. That is, the parking lot recommendation unit 107 may generate recommendation information exclusively for indoor parking lots. The parking lot recommendation unit 107 may generate recommendation information for parking lots based on the evaluation value calculated by the parking lot evaluation unit 106 when the weather information does not meet a predetermined condition, and generate recommendation information for parking lots based on the evaluation value calculated by the parking lot evaluation unit 106 and the indoor information when the weather information meets the predetermined condition. That is, any of indoor parking lots may be recommended based on the evaluation value when the weather information meets a predetermined condition. For example, recommendation information may be generated using the indoor information only when the type of weather is rainy or snowy, recommendation information may be generated using the indoor information when at least one of the air temperature, precipitation amount, and wind speed is more than a predetermined threshold, or recommendation information may be generated using the indoor information when the type of weather and the air temperature etc. meet a predetermined condition. In this manner, recommendation information is generated also in consideration of whether the parking lot is an indoor parking lot or an outdoor parking lot. Therefore, a recommendation can be made more appropriately.

With the present embodiment, a suitable parking lot can be recommended also in the following situation, for example. When the air temperature is significantly high on a sunny day, the inside of the vehicle 90 that is parked in an outdoor parking lot becomes hot. In order to avoid such a situation, recommendation information exclusively for indoor parking lots may be generated using the indoor information when the air temperature is a predetermined threshold or more on a sunny day, for example. Consequently, it is possible to select a parking lot in which the inside of a vehicle does not become hot. The example of use of the indoor information described above is merely exemplary, and it is a matter of course that the indoor information may be used on the assumption of other situations.

The present disclosure is not limited to the embodiments described above, and can be modified, as appropriate, without departing from the scope and spirit of the present disclosure. For example, in the embodiments described above, the parking lots as recommendation candidates are parking lots around the destination. However, the parking lots as recommendation candidates may be parking lots around the present location. In this case, the specific location described above is the present location, rather than the destination. In addition, the specific location is not limited to the destination or the present location, and may be a different location.

In the parking lot recommendation system 1 described above, in addition, the parking lot recommendation process is performed by the information processing device 10 and the terminal device 20. However, at least a part of the processes described as being performed by the information processing device 10 may be performed by the terminal device 20, and at least a part of the processes described as being performed by the terminal device 20 may be performed by the information processing device 10. In addition, at least a part of the processes described as being performed by the information processing device 10 or the terminal device 20 may be performed by a different device.

An information processing device according to a first aspect of the present disclosure includes an information processing device comprising one or more processors configured to: acquire an indoor distance and an outdoor distance of a transfer route from each of a plurality of parking lots as recommendation candidates to a specific location; acquire weather information on weather around the specific location; calculate an evaluation value based on the indoor distance and the outdoor distance for each of the parking lots, the evaluation value being a value varying depending on the weather information; and generate recommendation information for a parking lot based on the evaluation value.

With the aspect described above, an evaluation of a parking lot in accordance with the weather can be obtained in consideration of both the indoor distance and the outdoor distance. Therefore, it is possible to recommend a parking lot that is suitable for the weather, among the parking lots as departure places of transfer routes of which a destination is the specific location and which includes both indoor and outdoor paths.

In the aspect described above, the weather information may include a type of the weather around the specific location. With the configuration described above, an evaluation of a parking lot in accordance with the type of weather can be obtained in consideration of both the indoor distance and the outdoor distance. Therefore, it is possible to recommend a parking lot that is suitable for the type of weather, among the parking lots as the departure places of the transfer routes of which the destination is the specific location and which includes both indoor and outdoor paths.

In the aspect described above, the weather information may include at least one of an air temperature, precipitation amount, humidity, and wind speed around the specific location. With the configuration described above, an evaluation of a parking lot in accordance with the air temperature etc. can be obtained in consideration of both the indoor distance and the outdoor distance. Therefore, it is possible to recommend a parking lot that is suitable for the air temperature etc., among the parking lots as the departure places of the transfer routes of which the destination is the specific location and which includes both indoor and outdoor paths.

In the aspect described above, the one or more processors may be configured to calculate the evaluation value by respectively weighting the indoor distance and the outdoor distance with parameter values, and correct the parameter values when a user selects a parking lot that is different from the parking lot recommended in the recommendation information. With such a configuration, the evaluation value calculation method is corrected, since the parameter values for the weighting are corrected when the recommendation by the information processing device and the selection by the user do not coincide with each other. Therefore, it is possible to make a recommendation that suits the preference of the user.

In the aspect described above, the one or more processors may be configured to calculate the evaluation value by respectively weighting the indoor distance and the outdoor distance with parameter values, and set the parameter values based on an instruction related to weighting from a user. With such a configuration, the parameter values for the weighting are set in accordance with an instruction from the user. Therefore, the user can adjust the evaluation value calculation method such that recommendation that suits the preference of the user is obtained.

In the aspect described above, the one or more processors may be configured to acquire indoor information that indicates whether each of the parking lots is an indoor parking lot or an outdoor parking lot, and generate the recommendation information based on the evaluation value and the indoor information. With the configuration described above, recommendation information is generated also in consideration of whether the parking lot is an indoor parking lot or an outdoor parking lot. Therefore, a recommendation can be made more appropriately.

A parking lot recommendation system according to a second aspect of the present disclosure includes an information processing device and a terminal device. The information processing device includes one or more first processors configured to acquire an indoor distance and an outdoor distance of a transfer route from each of a plurality of parking lots as recommendation candidates to a specific location, acquire weather information on weather around the specific location, calculate an evaluation value based on the indoor distance and the outdoor distance for each of the parking lots, the evaluation value being a value varying depending on the weather information, and generate recommendation information for a parking lot based on the evaluation value. The terminal device includes one or more second processors configured to cause an output device to output the parking lot recommended by the first processors.

With the aspect described above, an evaluation of a parking lot in accordance with the weather can be obtained in consideration of both the indoor distance and the outdoor distance. Therefore, it is possible to recommend a parking lot that is suitable for the weather, among the parking lots as departure places of transfer routes of which a destination is the specific location and which includes both indoor and outdoor paths.

In the aspect described above, the one or more second processors may be configured to receive an input to designate a destination from a user, and notify the one or more first processors of the destination designated in the input. The one or more first processors may be configured to acquire the indoor distance and the outdoor distance using the destination notified by the one or more second processors as the specific location. With the configuration described above, the indoor distance and the outdoor distance of a transfer route from a parking lot to the destination are acquired, and an evaluation value is calculated based on such distances. Therefore, it is possible to recommend a parking lot that is suitable for visiting the destination.

In the aspect described above, the weather information may include a type of the weather around the specific location. With the configuration described above, an evaluation of a parking lot in accordance with the type of weather can be obtained in consideration of both the indoor distance and the outdoor distance. Therefore, it is possible to recommend a parking lot that is suitable for the type of weather, among the parking lots as the departure places of the transfer routes of which the destination is the specific location and which includes both indoor and outdoor paths.

In the aspect described above, the weather information may include at least one of an air temperature, precipitation amount, humidity, and wind speed around the specific location. With the configuration described above, an evaluation of a parking lot in accordance with the air temperature etc. can be obtained in consideration of both the indoor distance and the outdoor distance. Therefore, it is possible to recommend a parking lot that is suitable for the air temperature etc., among the parking lots as the departure places of the transfer routes of which the destination is the specific location and which includes both indoor and outdoor paths.

In the aspect described above, the one or more second processors may be configured to calculate the evaluation value by respectively weighting the indoor distance and the outdoor distance with parameter values, and correct the parameter values when a user selects a parking lot that is different from the parking lot recommended in the recommendation information. With such a configuration, the evaluation value calculation method is corrected, since the parameter values for the weighting are corrected when the recommendation by the information processing device and the selection by the user do not coincide with each other. Therefore, it is possible to make a recommendation that suits the preference of the user.

In the aspect described above, the one or more second processors may be configured to calculate the evaluation value by respectively weighting the indoor distance and the outdoor distance with parameter values, and set the parameter values based on an instruction related to weighting from a user. With such a configuration, the parameter values for the weighting are set in accordance with an instruction from the user. Therefore, the user can adjust the evaluation value calculation method such that recommendation that suits the preference of the user is obtained.

In the aspect described above, the one or more second processors may be configured to acquire indoor information that indicates whether each of the parking lots is an indoor parking lot or an outdoor parking lot, and generate the recommendation information based on the evaluation value and the indoor information. With the configuration described above, recommendation information is generated also in consideration of whether the parking lot is an indoor parking lot or an outdoor parking lot. Therefore, a recommendation can be made more appropriately.

A parking lot recommendation method according to a third aspect of the present disclosure includes: acquiring, by one or more processors, an indoor distance and an outdoor distance of a transfer route from each of a plurality of parking lots as recommendation candidates to a specific location; acquiring, by the one or more processors, weather information on weather around the specific location; calculating, by the one or more processors, an evaluation value based on the indoor distance and the outdoor distance for each of the parking lots, the evaluation value being a value varying depending on the weather information; and generating, by the one or more processors, recommendation information for a parking lot based on the evaluation value.

With the aspect described above, an evaluation of a parking lot in accordance with the weather can be obtained in consideration of both the indoor distance and the outdoor distance. Therefore, it is possible to recommend a parking lot that is suitable for the weather, among the parking lots as departure places of transfer routes of which a destination is the specific location and which includes both indoor and outdoor paths.

In the aspect described above, the weather information may include a type of the weather around the specific location. With the configuration described above, an evaluation of a parking lot in accordance with the type of weather can be obtained in consideration of both the indoor distance and the outdoor distance. Therefore, it is possible to recommend a parking lot that is suitable for the type of weather, among the parking lots as the departure places of the transfer routes of which the destination is the specific location and which includes both indoor and outdoor paths.

In the aspect described above, the weather information may include at least one of an air temperature, precipitation amount, humidity, and wind speed around the specific location. With the configuration described above, an evaluation of a parking lot in accordance with the air temperature etc. can be obtained in consideration of both the indoor distance and the outdoor distance. Therefore, it is possible to recommend a parking lot that is suitable for the air temperature etc., among the parking lots as the departure places of the transfer routes of which the destination is the specific location and which includes both indoor and outdoor paths.

In the aspect described above, the evaluation value may be calculated by respectively weighting the indoor distance and the outdoor distance with parameter values. The parking lot recommendation method may further include correcting, by the one or more processors, the parameter values when a user selects a parking lot that is different from the parking lot recommended in the recommendation information. With such a configuration, the evaluation value calculation method is corrected, since the parameter values for the weighting are corrected when the recommendation by the one or more processors and the selection by the user do not coincide with each other. Therefore, it is possible to make a recommendation that suits the preference of the user.

In the aspect described above, the evaluation value may be calculated by respectively weighting the indoor distance and the outdoor distance with parameter values. The parking lot recommendation method may further include setting, by the one or more processors, the parameter values based on an instruction related to weighting from a user. With such a configuration, the parameter values for the weighting are set in accordance with an instruction from the user. Therefore, the user can adjust the evaluation value calculation method such that recommendation that suits the preference of the user is obtained.

In the aspect described above, the parking lot recommendation method may further include acquiring, by the one or more processors, indoor information that indicates whether each of the parking lots is an indoor parking lot or an outdoor parking lot. The recommendation information may be generated based on the evaluation value and the indoor information. With the configuration described above, recommendation information is generated also in consideration of whether the parking lot is an indoor parking lot or an outdoor parking lot. Therefore, a recommendation can be made more appropriately.

Anon-transitory storage medium according to a fourth aspect of the present disclosure storing instructions that are executable by one or more processors and that cause the one or more processors to perform functions includes: acquiring an indoor distance and an outdoor distance of a transfer route from each of a plurality of parking lots as recommendation candidates to a specific location; acquiring weather information on weather around the specific location; calculating an evaluation value based on the indoor distance and the outdoor distance for each of the parking lots, the evaluation value being a value varying depending on the weather information; and generating recommendation information for a parking lot based on the evaluation value.

With the aspect described above, an evaluation of a parking lot in accordance with the weather can be obtained in consideration of both the indoor distance and the outdoor distance. Therefore, it is possible to recommend a parking lot that is suitable for the weather, among the parking lots as departure places of transfer routes of which a destination is the specific location and which includes both indoor and outdoor paths.

What is claimed is:

1. An information processing device comprising one or more processors configured to:
acquire an indoor distance and an outdoor distance of a transfer route from each of a plurality of parking lots as recommendation candidates to a specific location;
acquire weather information on weather around the specific location;
calculate an evaluation value based on the indoor distance and the outdoor distance for each of the parking lots, the evaluation value being a value varying depending on the weather information; and
generate recommendation information for a parking lot based on the evaluation value.

2. The information processing device according to claim 1, wherein the weather information includes a type of the weather around the specific location.

3. The information processing device according to claim 1, wherein the weather information includes at least one of an air temperature, precipitation amount, humidity, and wind speed around the specific location.

4. The information processing device according to claim 1, wherein the one or more processors are configured to
calculate the evaluation value by respectively weighting the indoor distance and the outdoor distance with parameter values, and
correct the parameter values when a user selects a parking lot that is different from the parking lot recommended in the recommendation information.

5. The information processing device according to claim 1, wherein the one or more processors are configured to
calculate the evaluation value by respectively weighting the indoor distance and the outdoor distance with parameter values, and
set the parameter values based on an instruction related to weighting from a user.

6. The information processing device according to claim 1, wherein the one or more processors are configured to:
acquire indoor information that indicates whether each of the parking lots is an indoor parking lot or an outdoor parking lot; and
generate the recommendation information based on the evaluation value and the indoor information.

7. A parking lot recommendation system comprising:
an information processing device that includes one or more first processors configured to
acquire an indoor distance and an outdoor distance of a transfer route from each of a plurality of parking lots as recommendation candidates to a specific location,
acquire weather information on weather around the specific location,
calculate an evaluation value based on the indoor distance and the outdoor distance for each of the parking lots, the evaluation value being a value varying depending on the weather information, and
generate recommendation information for a parking lot based on the evaluation value; and
a terminal device that includes one or more second processors configured to cause an output device to output the parking lot recommended by the first processors.

8. The parking lot recommendation system according to claim 7, wherein:
the one or more second processors are configured to
receive an input to designate a destination from a user, and
notify the one or more first processors of the destination designated in the input; and
the one or more first processors are configured to acquire the indoor distance and the outdoor distance using the destination notified by the one or more second processors as the specific location.

9. The parking lot recommendation system according to claim 7, wherein the weather information includes a type of the weather around the specific location.

10. The parking lot recommendation system according to claim 7, wherein the weather information includes at least one of an air temperature, precipitation amount, humidity, and wind speed around the specific location.

11. The parking lot recommendation system according to claim 7, wherein
the one or more second processors are configured to
calculate the evaluation value by respectively weighting the indoor distance and the outdoor distance with parameter values, and
correct the parameter values when a user selects a parking lot that is different from the parking lot recommended in the recommendation information.

12. The parking lot recommendation system according to claim 7, wherein
the one or more second processors are configured to
calculate the evaluation value by respectively weighting the indoor distance and the outdoor distance with parameter values, and
set the parameter values based on an instruction related to weighting from a user.

13. The parking lot recommendation system according to claim 7, wherein
the one or more second processors are configured to:
acquire indoor information that indicates whether each of the parking lots is an indoor parking lot or an outdoor parking lot and
generate the recommendation information based on the evaluation value and the indoor information.

14. A parking lot recommendation method comprising:
acquiring, by one or more processors, an indoor distance and an outdoor distance of a transfer route from each of a plurality of parking lots as recommendation candidates to a specific location;
acquiring, by the one or more processors, weather information on weather around the specific location;
calculating, by the one or more processors, an evaluation value based on the indoor distance and the outdoor distance for each of the parking lots, the evaluation value being a value varying depending on the weather information; and
generating, by the one or more processors, recommendation information for a parking lot based on the evaluation value.

15. The parking lot recommendation method according to claim 14, wherein the weather information includes a type of the weather around the specific location.

16. The parking lot recommendation method according to claim 14, wherein the weather information includes at least one of an air temperature, precipitation amount, humidity, and wind speed around the specific location.

17. The parking lot recommendation method according to claim 14, wherein:
the evaluation value is calculated by respectively weighting the indoor distance and the outdoor distance with parameter values; and
the parking lot recommendation method further comprises correcting, by the one or more processors, the parameter values when a user selects a parking lot that is different from the parking lot recommended in the recommendation information.

18. The parking lot recommendation method according to claim 14, wherein:
the evaluation value is calculated by respectively weighting the indoor distance and the outdoor distance with parameter values; and
the parking lot recommendation method further comprises setting, by the one or more processors, the parameter values based on an instruction related to weighting from a user.

19. The parking lot recommendation method according to claim 14, further comprising acquiring, by the one or more processors, indoor information that indicates whether each of the parking lots is an indoor parking lot or an outdoor parking lot, wherein the recommendation information is generated based on the evaluation value and the indoor information.

20. A non-transitory storage medium storing instructions that are executable by one or more processors and that cause the one or more processors to perform functions comprising:
acquiring an indoor distance and an outdoor distance of a transfer route from each of a plurality of parking lots as recommendation candidates to a specific location;
acquiring weather information on weather around the specific location;
calculating an evaluation value based on the indoor distance and the outdoor distance for each of the parking lots, the evaluation value being a value varying depending on the weather information; and
generating recommendation information for a parking lot based on the evaluation value.
